(19) United States
(12) Patent Application Publication
(10) Pub. No.: US 2024/0160463 A1
(43) Pub. Date: May 16, 2024

(54) SECURE DRIVE FOR COMPUTER SYSTEMS

(71) Applicant: Everything Blockchain Technology Corp., Jacksonville, FL (US)

(72) Inventor: Cedric Harris, Sugarland, TX (US)

(73) Assignee: Everything Blockchain Technology Corp., Jacksonville, FL (US)

(21) Appl. No.: 18/214,204

(22) Filed: Jun. 26, 2023

Related U.S. Application Data
(60) Provisional application No. 63/356,165, filed on Jun. 28, 2022.

(51) Int. Cl. G06F 9/455

(52) U.S. Cl. CPC G06F 9/45558; G06F 2009/45587

(57) ABSTRACT

A secure computer drive system includes an application programming interface, a graphical user, and a distributed computer system. The application programming interface provides a plurality of functions associated with a computer interface that are accessible to a computer application. The graphical user interface is coupled to the application programming interface, drives a computer display to display contents of the secure computer drive system, and receives user inputs for changing the contents using an operating system file explorer. The distributed computer system is implemented using an event actor architecture that maintains a chain-of-events consensus algorithm.

This application claims priority to provisional application U.S. 63/356,165, filed Jun. 28, 2022, the entire contents of which are incorporated herein by reference.

### FIELD

The present disclosure relates generally to security, and more particularly to performance and security enhancements for blockchain systems using distributed ledgers.

### BACKGROUND

Ransomware is a type of malware that cryptographically blocks a user's access to his or her own data stored on a personal computer or mobile device, or threatens to publish a victim's private data unless a ransom is paid, typically in the form of cryptocurrency. Advanced ransomware attacks use a technique known as cryptoviral extortion. A typical attack starts when a hacker sends a Trojan horse file disguised as a legitimate file that tricks a user into downloading or opening a file received as an EMAIL attachment. Once the user opens the file, the Trojan horse encrypts the user's files using a public key, for which only the bad actor possesses the private key necessary to decrypt the files. Upon payment of the ransom, the bad actor provides the private key to the user, allowing the user to decrypt the user's own files. Typically, the ransomware attack requires a user action. However, at least one other known virus known as the “WannaCry” worm was able to travel automatically between computers without any user interaction.

The U.S. Federal Bureau of Investigation (FBI) reported that it received complaints of ransomware amounting to $49.1 M in 2021. However, sources believe that that actual costs to the US alone amount to several billion dollars, including ransom payments and lost productivity. Ransomware attacks are also growing rapidly. According to an article by David Draue in Cybercrime Magazine, the global costs of ransomware attacks are estimated to reach $265 B by the year 2031.

In view of the disruption of business and personal lives due to ransomware attacks, what is needed is a system and a technique to secure users' data better from these types of attacks.

### BRIEF DESCRIPTION OF THE DRAWINGS

FIG. 1 shows a conceptual diagram of how an event actor works;

FIG. 2 shows an illustration of the event architecture;

FIG. 3 shows an illustration of a series of events as part of the QueryChain architecture over a traditional Merkle Tree using the chain-of-events consensus algorithm;

FIG. 4 shows a distributed computer system implementing a chain-of-events consensus algorithm on a Kubernetes cluster according to various embodiments disclosed herein;

FIG. 5 shows a software operating environment for a computer system with a secure drive using the QueryChain architecture according to various embodiments described herein; and

FIG. 6 shows a block diagram of a data processing system capable of creating and using a secure drive according to various embodiments disclosed herein.

In the following description, the use of the same reference numerals in different drawings indicates similar or identical items. Unless otherwise noted, the word “coupled” and its associated verb forms include both direct connection and indirect electrical connection by means known in the art, and unless otherwise noted any description of direct connection implies alternate embodiments using suitable forms of indirect electrical connection as well.

### DETAILED DESCRIPTION OF ILLUSTRATIVE EMBODIMENTS

The present disclosure addresses performance and security problems inherent to existing blockchain architectures by alleviating the common and accepted approach to the mining of blockchain transactions through the introduction of a new atomic unit of compute called the “Event Actor”. The Event Actor is based on the use of a mathematically unique chain-of-events to form an instantaneous consensus that can be used to overcome the repetitive and intensive processing (mining) of proofs for a parent Merkle Tree associated with a specific blockchain transaction.

In various embodiments, a system is configured to process transaction verification operations for a decentralized application via an event actor design architecture, where the system is configured to receive a block related to at least one transaction, the block including a ledger reading set and cryptographic signature associated with at least one transaction to be authenticated. The system includes an event queue through which event-based communications occur instantaneously in a series of mathematically unique patterns over a distributed network system of stateful nodes that operate as a digital twin to blockchain blocks to alleviate blockchain mining latency.

In one aspect, the system is configured such that incoming web requests arrive over HTTP protocol and activate an indeterminant series of event actor microservices, whereby the event actor receives asynchronous event-based notifications to alleviate blockchain latency.

In a related aspect, the system is configured such that the traditional reliance on persistent storage is alleviated in favor of stateful event actors to maintain the blockchain ledger, whereby horizontal scaling of services is achieved by extending its Google Kubernetes cluster of nodes running containerized application images within a daemonset.

In one aspect, the architecture is configured in an event-based architecture based on the Command Query Request Segregation (CQRS) design pattern, in which incoming requests are streamed as an array of binary bytes transmitted over the Representational State Transfer (REST) protocol and translated into a series of events distributed over the Google Kubernetes cluster.

In another aspect, each private block key and parent Merkle Tree hash key of the block is persisted through the event actor, whereby a child event actor is linked to its parent Merkle Tree root, whereby as a new transaction is added to an existing Merkle Tree, an event is distributed between newly created child events and its parent Merkle Tree.

In a related aspect, the system is configured such that when a parent Merkle Tree receives an event of the of a newly added transaction, the parent Merkle Tree updates its corresponding Merkle Tree root hash key, whereby the updated Merkle Tree root hash key is not broadcast to any other sibling event actors because of previous private keys sharing a common public key used to keep all ledger blocks in sync.

In another aspect, the system is configured to create restrictions between event actors through zero trust security and discoverability through a unique chain-of-events to form a consensus herein referred to as the “Chain-of-events Consensus Algorithm”.

In one aspect, the system supports the OpenAPI protocol via the Swagger development tools from SmartBear Software of Somerville, Massachusetts for incoming requests.

In a related aspect, the system supports the OpenAPI protocol, and wherein the topology of the architecture is configured to be hosted either in the cloud or on a client's premise and incorporates a series of decentralized servers via proxy servers to distribute OpenAPI traffic across a cluster of daemonset event actors.

In another related aspect, the system supports the publisher/subscriber design pattern to accommodate persisted TCP/IP connections configured to persist a single bi-directional connection between a client and an event actor within a cluster for greater responsiveness.

In a further related aspect, each event actor node communicates with each other via asynchronous events over a persisted TCP/IP connection.

In various embodiments, a method of processing transactions for a decentralized application is disclosed, the method being implemented on a computing device includes an event actor architecture based on the CQRS design pattern, where the architecture is configured to receive a block related to at least one transaction, the block includes a cryptographic signature associated with the at least one transaction to be authenticated that is initiated through an external system communicating over an OpenAPI RESTful request.

In one aspect, incoming OpenAPI RESTful requests activate event actor microservices.

In another aspect, all dependencies on traditional persisted data storage are alleviated in favor of stateful event actors in real-time used to maintain the blockchain ledger, whereby horizontal scaling of services is achieved through extending the number of nodes onto the Google Kubernetes cluster.

In a related aspect, events are raised over the distributed cluster of nodes using binarily serialized data based on the MessagePack serialization protocol.

In another aspect, the CQRS design architecture of the event actors is used to make all block data indexable without the necessity of making multiple copies of the same data which makes the near-instantaneous retrieval of data over a distributed blockchain cluster attainable in a manner not attainable by traditional mining.

A new architecture disclosed herein provides a virtual drive based on the QueryChain platform that allows users to reduce or eliminate ransomware attacks. This new architecture is able to be integrated with common operating systems environments, including the Windows operating system from Microsoft, Inc. of Redmond, WA, the Apple desktop operating system and mobile operating system known as “iOS” available from Apple Computer, inc. of Cupertino, CA, and any other operating system.

### The Querychain Architecture

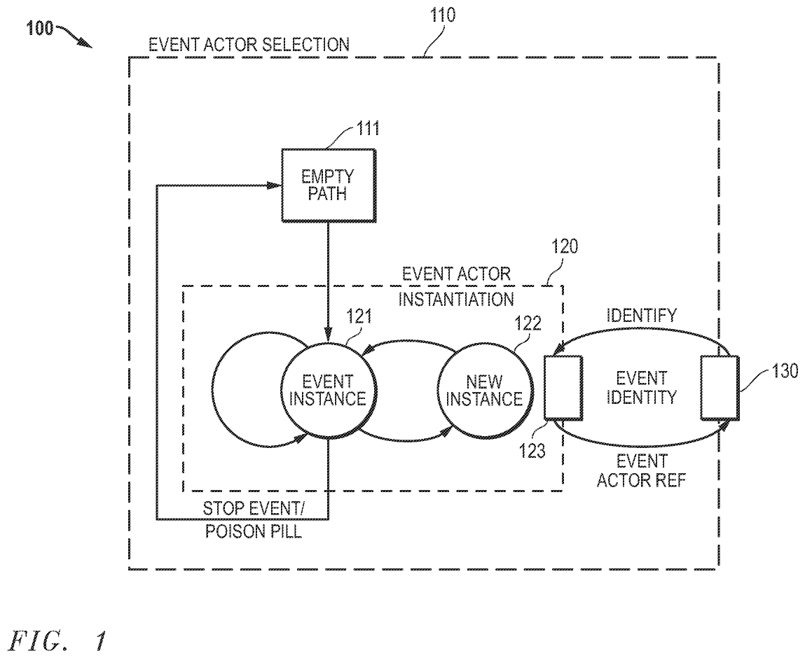

FIG. 1 shows a conceptual diagram 100 of how an event actor works using an event actor selection 110. Event actor selection 110 starts with an empty path 111, in which an event actor is assigned to a subject. A path is then reserved for that event actor, a random UID (unique identification) is assigned to an instantiation of the event actor, an instance is created, and a pre-start routine is called on the instance. An event actor instantiation 120 belongs to a particular path which has a UID and an event queue. A new instantiation replaces an old instantiation, and a post-restart function is assigned which calls on the new instantiation. After the new instantiation starts, a pre-restart function is called on the old instance. Once the event actor is identified in this manner, event actor selection 110 represents a path (or multiple paths with a wildcard) that allows for resolution of the underlying event actor reference by triggering an identify event between interfaces 130 and 123. The event reference represents the instantiation, in which the event reference has a path and UID, but hides it. A Stop event, or alternatively a Poison-Pill event, can be activated, depending on the instructions of the event, to allow the path to be used again.

The problem behind the inherent scalability barriers to blockchain technology is the architecture. More specifically, the root problem is the lack of a distributed architecture. The seminal objective of the blockchain technology was secure transactions through the immutability of its distributed ledgers, but scalability was not the primary objective.

Unsuccessful solutions to blockchain scalability have incorporated everything from Graphical Processing Unit (GPU) farms that use computationally intensive single instruction, multiple data (SIMD) processors, to large clusters of virtual machines (VMs). Various embodiments of the architecture disclosed herein use several design patterns for distributed computing to solve scalability challenges. This architecture is known as the “QueryChain” architecture.

Private or permissioned blockchain networks are far more secure than public blockchain networks. Private blockchain networks require a massive private cloud infrastructure to function at scale. According to some embodiments, the QueryChain architecture is coupled with a private cloud blockchain network based on the Kubernetes orchestration platform developed by Google, Inc. of Mountain View, California, to provide both a highly secure blockchain network with the performance of a public blockchain network. In various embodiments, the QueryChain architecture uses an event-based model based on the CQRS design pattern to make communications highly scalable. In some embodiments, a system using the QueryChain architecture receives external OpenAPI RESTful requests. However, internally, services communicate through an event architecture based on the CQRS design pattern at the microservices level. In a related aspect, this event actor architecture uses the faster protocol based on the Google remote procedure call (gRPC) protocol instead of the slower TCP/IP protocol.

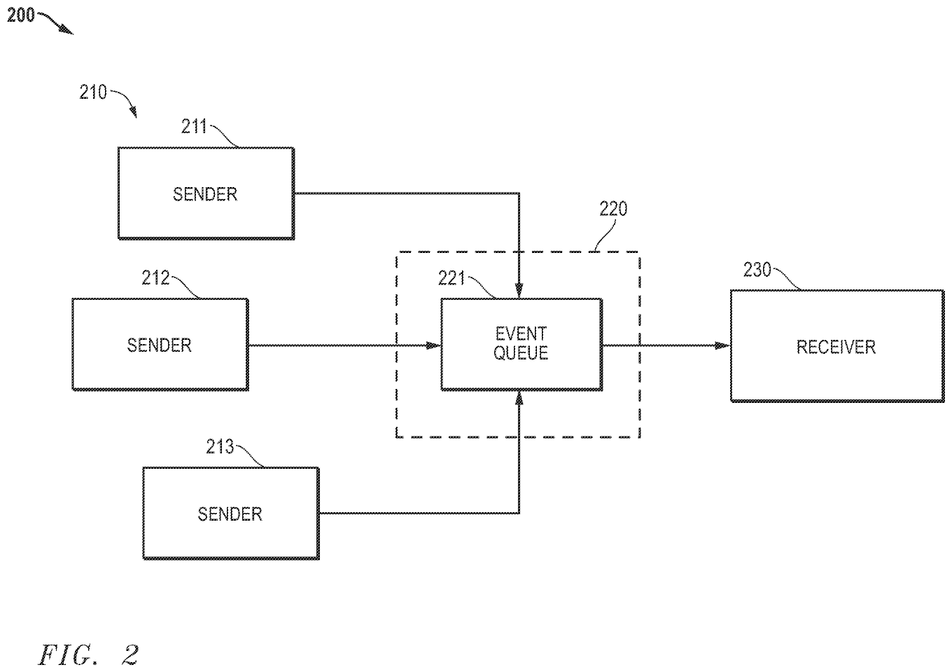

FIG. 2 illustrates a conceptual diagram 200 of the event architecture. In various embodiments, the QueryChain architecture uses the CQRS design pattern. Briefly, an event is triggered from one of a group of senders 210 such as exemplary senders 211, 212, and 213 to an event actor broker 220, in which the event enters an event queue 221 that routes and distributes incoming events that to the appropriate receiver 230. The data payload of an event envelope may include, but is not limited to, non-structured JSON (Java Script object notation), XML (extensible markup language), CSV (comma-separated values), JSV, SOAP (simple object access protocol), and Byte Arrays formats. In some embodiments, the internal serialization of the event payload uses the MessagePack serialization protocol, which is preferred to the Protocol Buffers serialization protocol which creates external dependencies that do not exist with the MessagePack serialization protocol.

Most blockchain solutions use numerous containerized service instances and/or GPUs to offload the process intensive work of mining and both creating and validating proofs. The architecture disclosed herein, however, uses an event actor architecture that may be based on the CQRS design pattern to create a digital twin of each blockchain transaction.

Event actors are primitive units of computation. A key advantage of event actors is that they are extremely fast due to not creating a context boundary between a sender and a receiver due to the need to wait for responses. Moreover, event actors are designed specifically for solving the problem of distributed computing as each event actor contains an event broker used in support of intra-service communications. Event actors are completely isolated and never share memory and are thereby stateful. The stateful aspect of event actors allows for each private key and parent Merkle Tree hash to be persistent and used to link the child event actor to its parent Merkle Tree root. As new transactions are added to an existing Merkle Tree, instantaneous events are brokered between the newly spawned children and its Merkle Tree digital twin. As a Merkle Tree digital twin receives events of newly added transactions, the Merkle Tree digital twin updates its Merkle Tree root hash key. In turn, this updated Merkle Tree root hash key does not need to rebroadcast to siblings due to the unique cryptographic signature keeping all previous private blockchain keys in synchronization. Thus, event actors represent a more powerful means of addressing scalability challenges than typical microservices considering that one can spawn more on a single box than a typical microservices. As disclosed herein, as event actors are spawned, the QueryChain architecture achieves greater density than relying on numerous containerized service instances and/or GPUs in the cloud.

Subtle vulnerabilities within the seemingly impervious blockchain cryptography have surfaced in recent years. These vulnerabilities arose through the online exchanges where cryptocurrency wallets are stored. In these instances, basic security to safeguard public and private keys would work. However, it is the more sophisticated 51% attack that was the most alarming. In the 51% attack hackers sought to achieve a majority of computing power to control the mining effort that proofs depend on. Simply put, if one gains a majority (51%) of the node computing power in a network then one needs to establish a consensus needed to establish what transactions will become accepted by the minority (49%) of the nodes. The architecture as disclosed herein is based on the “Raft” consensus algorithm not to agree on transactions, but on the existence and location of node actors within its cluster. By restricting the use of consensus algorithms to actors, node discoverability transactions are never made vulnerable to brute force denial of service attacks such as 51%.

The chain-of-events consensus algorithm described herein addresses the fundamental performance and security issues surrounding blockchain. The fundamental performance issues common to blockchain is its inability to scale. Currently, blockchain can only process a maximum of 15 contracts per minute. This makes widespread adoption of blockchain difficult, at best.

As disclosed herein, the event actor architecture may be based on the CQRS design pattern. The event actor architecture is used to provide stateful microservices that are highly scalable and responsive to streaming events. Instead of constantly iterating over blocks in a process intensive manner (a process known as “mining for blockchain contracts”), the architecture as disclosed herein utilizes the event actor architecture to define a unique chain-of-events create an instantaneous consensus of the location and validity of any block of data in a ledger.

The event actor architecture is an event-based approach used to facilitate a highly scalable system of stateful yet immutable nodes to operate as a digital twin of blockchain blocks associated with transactional data. The event actor architecture alleviates excessive latency common to of the traditional process intensive mining of blockchain that is based on messaging.

In some embodiments, a plugin module is used to create a unique digital signature based on the heuristics of the user's system behavior combined with the blockchain private keys. This heuristic-based security mechanism allows the event actor architecture to detect anomalies that trigger multifactor authentication in the form of email communications to guard against ransomware and identity theft attacks, before access to sensitive blockchain data is granted.

In various embodiments, plugin modules utilize blockchain smart contracts to perform process automation through the event actor architecture based on the CQRS design pattern. In a related aspect, these modules utilize blockchain to provide automation of tasks through a smart contract scripting language that is added to the blockchain ledger as a specialized block that is run autonomously against every newly added block to the ledger. In another instance, the automation can create new blockchain ledgers and create calculated fields that retain state even in a disaster recovery scenario.

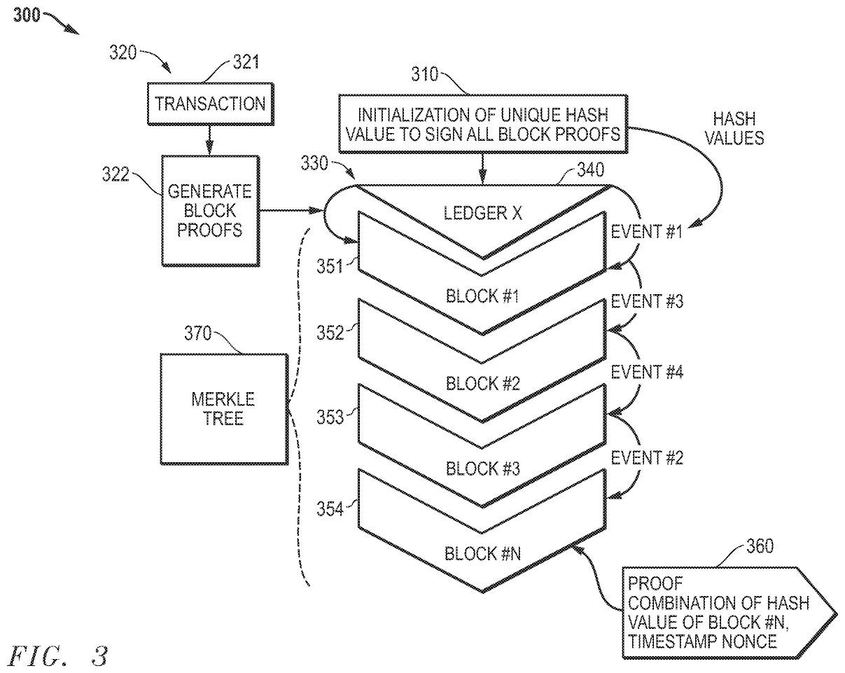

FIG. 3 shows an illustration of a flow 300 of a series of events as part of the QueryChain architecture over a traditional Merkle Tree using the chain-of-events consensus algorithm. Flow 300 starts with a box 310 in which the distributed computer system initializes a unique hash value that it will use to sign all block proofs in the blockchain. A transaction is added by boxes 320, in which in a box 321 the computer system receives a transaction, and in a box 322 the computer system generates block proofs for the transaction. A blockchain 330 includes a ledger 340 and an exemplary set of blocks 351-354 that are cryptographically linked in a growing chain-of-events. For example, the first transaction adds a block 351 labelled “BLOCK #1” to the blockchain by hashing its data and recording it in ledger 340. The computer system performs this pattern to add a series of blocks labelled “BLOCK #2”, “BLOCK #3”, and so on until a last block labelled “BLOCK #N” to the blockchain.

However, the events do not follow the sequential order of blocks in the ledger. For example, BLOCK #2 is tied to EVENT #3, BLOCK #3 is tied to EVENT #4, and so on until a last block, Block #N, is tied to EVENT #2. The chain-of-events for each block of data is mathematically unique. Each block uses zero-trust security to maintain affinity to the previous block within the chain-of-events. If an event triggers a communication with a block not tied to the proper chain-of-events, then the block rejects the communication with it, and access to its block data is denied. The location of any single block within ledger 340 is based on a unique combination of event patterns similar to that of a combination to a lock, or to the firing of synapses in the brain. A computer system implementing the chain-of-events consensus algorithm leverages the randomness of the chain-of-events in receiving and distributing the event actors among the compute nodes in the system to reject malicious communications that attempt to access the data in the system.

Flow 300 also creates a Merkle Tree 370 to maintain proofs for each block within the ledger. For example, as shown in box 360, the proof for Block #N is the combination of the hash value for Block #N and a timestamp nonce.

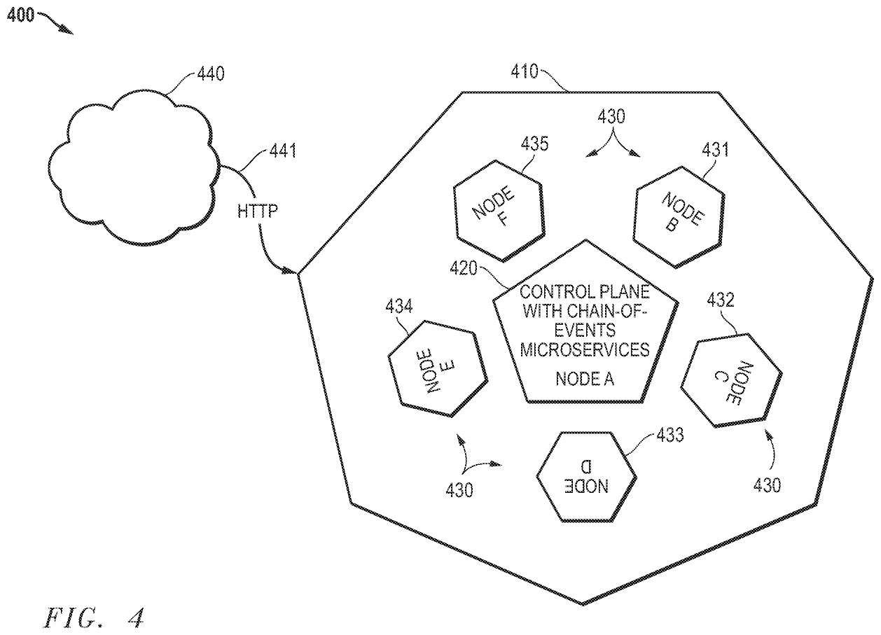

FIG. 4 shows a distributed computer system 400 implementing a chain-of-events consensus algorithm on a Kubernetes cluster 410 according to various embodiments disclosed herein. In some embodiments, Kubernetes cluster 410 includes multiple remote nodes that communicate with each other securely over public or private networks. In other embodiments, Kubernetes cluster 410 includes nodes that are co-located in a multi-node computer system, server, server farm, etc. that communication with each other over private networks.

Kubernetes cluster 410 includes a control plane 420 which is designated “Node A” and a series of nodes 431-435 labelled “Node B” through “Node F”, respectively. Control plane 420 includes a set of chain-of-events microservices that are used to establish the order and distribution of events between the compute nodes in distributed computer system 400. Each new request calls the microservices that are serialized in a unique order as they are processed through event queue 221 and spawned as Event Actors that are distributed across Kubernetes cluster 410. Thus, the system of receiving events and spawning and distributing Event Actors establishes the randomness that the Query Chain architecture exploits to provide additional security against attempts by bad actors.

For example, assume that an un-authorized attempt to access data is received by one of Nodes 431-435. The attempted access may reference data associated with an event actor, but the bad actor will not possess the correct chain-of-events to establish a proof-of-stake needed to access the data because this information is cryptographically known by authorized users but not known by bad actors. Thus, distributed computer system rejects the attempted access and foils the hack.

Moreover, the malicious access attempt can be rejected quickly without the need for the computationally intensive generation of block proofs needed by conventional blockchain architectures because each node operates as a digital twin to the blockchain blocks to alleviate the conventional blockchain mining latency. Thus, the Query Chain architecture with the chain-of-events consensus overcomes one of the core limitations of blockchain technology that has prevented more widespread adoption.

### Virtual Drive Architecture

As disclosed herein, a new virtual system drive allows the user to interact with a secure file system based on the QueryChain architecture in the same intuitive manner as non-QueryChain drives. In particular, the virtual drive system allows the user to interact through the user's operating system to perform common file storage tasks as if the virtual drive were physically present on the computer system or externally linked. The new virtual drive stores files using the Chain of Events consensus algorithm to establish proof of stake for the ability to access and modify existing files that would not be granted to a Trojan that attempted to access the user's files. By using blockchain technology, it maintains the immutability of data so that critical data cannot be cryptographically modified and therefore subject to a ransomware attack. This virtual drive system will have particular utility in industries that require a high degree of data security, such as patient medical records.

It also allows the application of data rights management, allowing the user to prevent unauthorized attacks from suspect locations. In particular, it can restrict data access from all but a single geolocation, preventing any remote hacking attempt. This system will now be described with reference to the schematic of an exemplary file system.

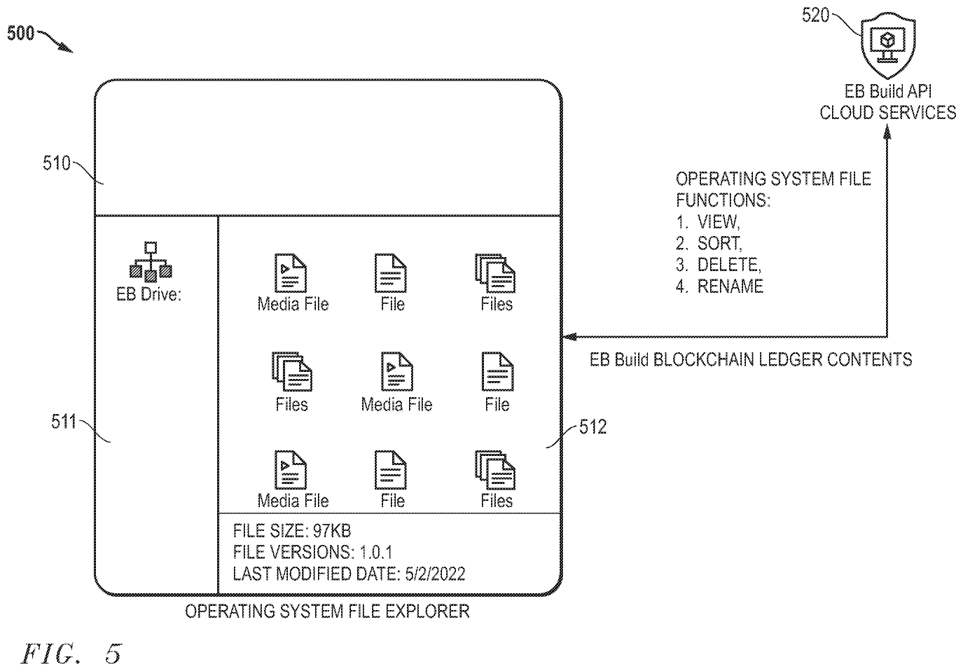

FIG. 5 shows a software operating environment 500 for a computer system with a secure drive using the QueryChain architecture according to various embodiments described herein. The operating environment is based on a computer system with a virtual drive constructed using the QueryChain architecture described above. When used in this vertically integrated system, the QueryChain architectural component is referred to as the “EB Build” component, and the secure drive is referred to as the “EB Drive” component.

Software operating environment 500 includes generally a computer display 510 and a application programming interface 520. Computer display 510 includes a secure drive icon 511 and a file directory 512. Secure drive icon 511 is a visual representation of the secure drive. The EB Drive component appears to the user as an icon on the display in the same way that a normal file location, such as a resident hard disk drive, a resident hard disk drive partition, an offsite enterprise server, a remote cloud services server, and the like, would be displayed. A user interacts with the EB Drive component in the same way he or she interacts with other file locations, such as dragging and dropping files into the area of the screen displaying the EB Drive icon, opening the EB Drive component by double clicking on the EB Drive icon to navigate its file system to locate a desired file and open it up for printing, editing, and distributing, and the like. Thus, the EB Drive component leverages the built-in graphical user interface of the computer's operating system to interact with the user intuitively and in a manner with which he or she is already familiar.

File directory 512 is a visual display of files that the user has stored in the EB Drive component, and as shown in FIG. 5, includes an array of icons that include individual files, groups of related files, media files, and the like. File directory 512 could also be displayed as a list, a list with various metadata such as file size, version number, last modified data, and the like.

The graphical user interface file system also allows the user to interact with the EB Drive device via an application programming interface (API). In the disclosed embodiment, the user can interact with the EB Drive component using view, sort, delete, and rename functions. It should be apparent that this list of supported functions may vary in other embodiments. The API also returns EB Build blockchain ledger components to allow the user's software to provide a proof of stake by performing an instantaneous chain-of-events consensus as described above.

The EB Drive components includes three hierarchal levels. At the topmost level are the operating system file functions, including View, Sort, Delete, and Rename. The operating system's graphical user interface (GUI) allows the user to pick these functions intuitively. The upper level of the EB Drive component provides a set of APIs that are called in response to the interaction of the user with the display.

The next level includes the files that are stored on the EB Drive. These files include media files and normal files (i.e., non-media files). These files, when received, are distributed among the cloud services components in various chain-of-events patterns.

The lower level includes EB Build blockchain file components. As shown in FIG. 5, these include various metadata about the files such as file size, file version, and last modified date. Since these components are random to the user and to any bad actor attempting to access the data on the cloud services server, they provide an extra layer of randomness and therefore greatly enhanced security.

When the user directs the operating system to store a file initially on the EB Drive component, however, the EB Drive component operates differently than a normal file location. The storage action creates a chain-of-events blockchain in which the portions of the file or shards are distributed among event actors in the system as described earlier. As noted above, the chain-of-events consensus algorithm enhances the security of the system by leveraging the randomness among other events in the system so that each new event is created with a unique chain-of-events that is added to its blockchain ledger. In addition, each node maintains a digital twin of the transaction so that it can form a substantially instantaneous consensus of the proof of stake of the attempted access.

The secure entity shown in the embodiment of FIG. 5 is a cloud services server. The cloud services server has a multitude of nodes with distributed memory, and provides a sufficient amount of randomness when files are received and stored in the cloud services server to ensure a high degree of security. It presents to the host computer a set of APIs for interaction with the EP Build utility that forms the unique chain-of-events.

There are some additional aspects of the EB Drive component with the way the EB Drive component on the user's computer interacts with the secure cloud services server that provides distinct advantages. The first one is a “provision key” that identifies the EB Drive as an available drive to the operating system. There is also an API key to allow access of a user to the EB Drive.

The EB Build component also provides the ability to search for files on the cloud services server. The search would include files for which the user is able to establish a proof of stake through a chain of events consensus.

Finally, EB Build component incorporates data rights management (DRM) that includes additional file restrictions. For example, the user can restrict files to certain geographic locations, with optional biometric data to uniquely identify recipients to which access has been granted.

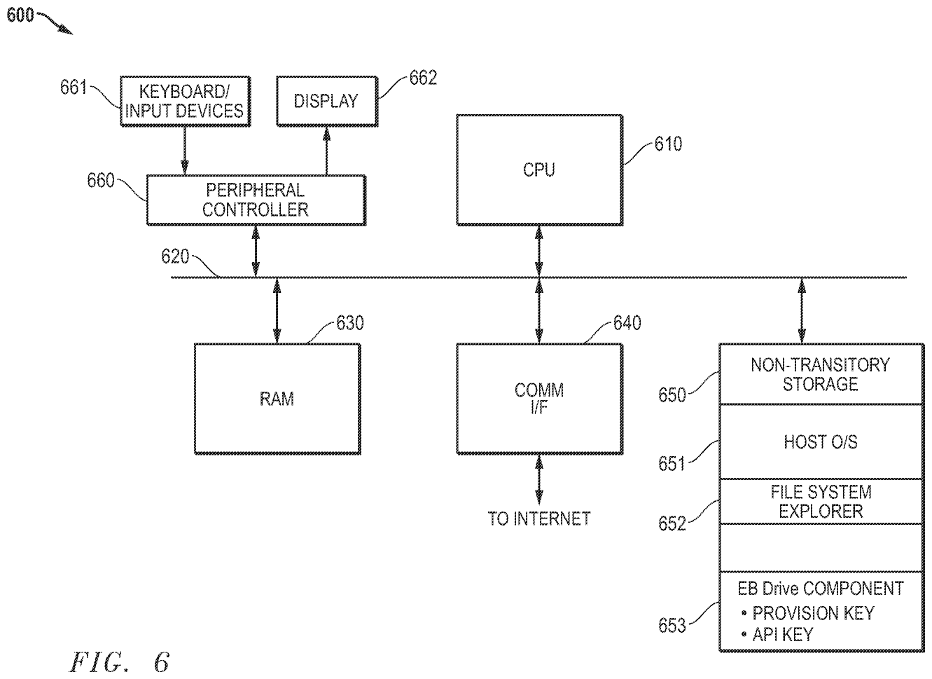

FIG. 6 shows a block diagram of a data processing system 600 capable of creating and using a secure drive according to various embodiments disclosed herein. Data processing system 600 includes generally a processor 610 labelled “CPU” connected to a bus 620, a volatile memory 630 labeled “RAM”, a communication interface circuit 640 labelled “COMM I/F”, a non-transitory storage medium 550, and a peripheral controller 660 along with associated input/output peripherals.

In the example shown in FIG. 6, volatile memory 630 is a random-access memory and thus volatile memory 630. Volatile memory 630 is a high-speed memory that stores application programs and data so they can be accessed by processor 610 at high speed. Communication interface circuit 640 is representative of a set of communication peripherals that are supported by data processing system 600. For example, if data processing system 600 were a laptop computer, then communication interface circuit 640 could include universal serial bus (USB) controllers, data link controllers such as IEEE 802.11 (WiFi) controllers, and the like. If data processing system 600 were a desktop computer, then communication interface circuit 640 could include universal serial bus (USB) controllers, data link controllers such as IEEE 802.3 (Ethernet) controllers, and the like. If data processing system 600 were a smart phone, then communication interface circuit 640 could include WiFi controllers, Bluetooth controllers, and the like.

Non-transitory storage 650 is a computer memory that maintains its state even when powered off. It can include a hard-disk driver (HDD), a solid-state drive, a FLASH memory, a remote memory such as a cloud storage drive, and the like. As shown in FIG. 6, it includes a host operating system 651, whose features will vary based on the type of data processing system. Host operating system 651 includes a file system explorer 652 that generates a graphical user interface with which the user can intuitively execute various file system activities. In addition, it has a portion known as an “EB DRIVE COMPONENT” 653 that includes data, cryptographic keys, etc. that allow it to connect easily to the remote drive. In particular, it includes the provision key and the API key as described above.

Peripheral controller 660 connects bus 620 to various low-end input/output devices. As shown in FIG. 6, these input/output devices include a keyboard or keypad and other input devices 661, and a display 662. Data processing system 600 uses display 662 to display the graphical user interface described above with respect to FIG. 5. The other input devices include a mouse, touchpad, or touchscreen to allow the user to interact with the objects displayed by the graphical user interface, and can include certain input devices such a camera, an audio input device, and the like by which data processing system 600 receives and relays biometric data for additional security when a user attempts to access the secure drive.

The basic features as well as the additional features allow the user to “future proof” their private data from additional hacking modes and exploits that may be developed in the future. For example, there has been much discussion about the ability of quantum computers to calculate private keys based on brute-force computing power.

Thus, a secure computer drive system has been described that improves the operation of a computer. For purposes of explanation, numerous specific details have been set forth to provide a thorough understanding of the description. It will be apparent, however, to one skilled in the art that implementations of the disclosure can be practiced without these specific details. In some instances, modules, structures, processes, features, and devices are shown in block diagram form to avoid obscuring the description. In other instances, functional block diagrams and flow diagrams have been shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Implementations of the disclosure may be made in hardware, firmware, software, or any suitable combination thereof. Aspects of the disclosure may be implemented as instructions stored on a machine-readable medium such as non-transitory storage 65—, which may be read and executed by one or more data processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory, and other suitable types of memory, and a machine-readable transmission media may include forms of propagated signals, such as carrier waves, infrared signals, digital signals, and others. Firmware, software, routines, or instructions may be described herein in terms of specific exemplary aspects and implementations of the disclosure and performing certain actions.

The system as disclosed herein may include a plurality of individual components (e.g., computer devices) each programmed with at least some of the functions described herein. In this manner, some components of system may perform some functions while other components may perform other functions, as would be appreciated. Reference to various features is described that may be preferences or requirements for some implementations, but not other implementations.

Thus, to the maximum extent allowed by law, the scope of the present invention is to be determined by the broadest permissible interpretation of the following claims and their equivalents, and shall not be restricted or limited by the foregoing detailed description.

What is claimed is:

1. A secure computer drive system, comprising:
an application programming interface that provides a plurality of functions associated with a computer interface that are accessible to a computer application;
a graphical user interface coupled to the application programming interface that drives a computer display to display contents of the secure computer drive system and receives user inputs for changing the contents using an operating system file explorer; and
a distributed computer system implemented using an event actor architecture that maintains a chain-of-events consensus algorithm.

2. The secure computer drive system of claim 1, wherein the distributed computer system is distributed across multiple remote nodes that communicate with each other securely over public or private networks.

3. The secure computer drive system of claim 1, wherein the distributed computer system is distributed across multiple remote nodes that are co-located in a multi-node computer system.

4. The secure computer drive system of claim 1, wherein the distributed computer system comprises a Kubernetes cluster.

5. The secure computer drive system of claim 1, wherein the graphical user interface displays the contents of the secure computer drive system in the same manner as a normal file location that is resident on at least one of a resident hard disk drive, a resident hard disk drive partition, an offsite enterprise server, a remote cloud services server.

6. The secure computer drive system of claim 1, wherein the plurality of functions include a plurality of: view, sort, delete, and rename.

7. The secure computer drive system of claim 1, wherein the distributed computer system comprises:
a cloud services server; and
a plurality of event actors, wherein:
in response to the cloud services server receiving a file storage request, the cloud services server creates a chain-of-events blockchain in which portions of a file are distributed among the plurality of event actors.

8. A data processing system for accessing a secure computer drive system, comprising:
a data processor; and
a non-transitory storage medium coupled to the data processor that comprises instructions that, when executed, cause the data processor to:
receive user input for creating a secure file;
initiate a remote communication with the secure computer drive system;
send a file creation request to the secure computer drive system;
cause a distributed computer system associated with the secure computer drive system to store data of the secure file across multiple nodes using an event actor architecture that maintains a chain-of-events consensus algorithm; and
display contents of the secure computer drive system according to a file system explorer in response to the distributed computer system storing data of the secure file.

9. The data processing system of claim 8, wherein:
the non-transitory storage medium further comprises instructions that, when executed, cause the data processor to:
send a file access request to the secure computer drive system; and
establish a proof of stake by reaching a chain-of-events consensus with the secure computer drive system.

10. The data processing system of claim 8, wherein:
the non-transitory storage medium further comprises instructions that, when executed, cause the data processor to:
provide data rights management data to the secure computer drive system; and
initiate the remote communication with the secure computer drive system in response to said data rights management data matching stored data rights management data of the secure computer drive system.

11. The data processing system of claim 8, wherein:
the non-transitory storage medium further comprises instructions that, when executed, cause the data processing system to:
store a provision key in response to the distributed computer system storing the data of the secure file, wherein an operating system of the data processing system identifies the secure computer drive system as an available drive in response to the provision key.

12. The data processing system of claim 8, wherein the file system explorer causes a graphical user interface to display the contents of the secure computer drive system in the same manner as a normal file location that is resident on at least one of a resident hard disk drive, a resident hard disk drive partition, an offsite enterprise server, and a remote cloud services server.

13. The data processing system of claim 8, wherein the instructions are adapted to interface the data processing system to an application programming interface of the secure computer drive system.

14. The data processing system of claim 13, wherein the application programming interface has at least a view function, a sort function, a delete function, and a rename function.

15. A method for accessing a secure computer drive system, comprising:
receiving user input for creating a secure file;
initiating, by a data processing system, a remote communication with the secure computer drive system;
sending a file creation request to the secure computer drive system;
causing a distributed computer system associated with the secure computer drive system to store data of the secure file across multiple nodes using an event actor architecture that maintains a chain-of-events consensus algorithm; and
displaying contents of the secure computer drive system on a display of the data processing system according to a file system explorer in response to the distributed computer system storing data of the secure file.

16. The method of claim 15, further comprising:
sending a file access request to the secure computer drive system; and
establishing by the secure computer drive system a proof of stake by reaching a chain-of-events consensus with the secure computer drive system.

17. The method of claim 15, further comprising:
providing data rights management data to the secure computer drive system; and
initiating the remote communication with the secure computer drive system in response to said data rights management data matching stored data rights management data of the secure computer drive system.

18. The method of claim 15, further comprising:
storing a provision key by the secure computer drive system in response to the distributed computer system storing the data of the secure file, wherein an operating system of the data processing system identifies the secure computer drive system as an available drive in response to the provision key.

19. The method of claim 15, wherein the file system explorer causes a graphical user interface to display the contents of the secure computer drive system in the same manner as a normal file location that is resident on at least one of a resident hard disk drive, a resident hard disk drive partition, an offsite enterprise server, and a remote cloud services server.

20. The method of claim 15, further comprising:
interfacing, by the data processing system, to the secure computer drive system using an application programming interface having at least a view function, a sort function, a delete function, and a rename function.
